(19) United States
(12) Patent Application Publication
(10) Pub. No.: US 2006/0097581 A1
(43) Pub. Date: May 11, 2006

(54) Push-pull device using in output of uninterruptible power system

(76) Inventor: Chun-Ching Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/981,643

(22) Filed: Nov. 5, 2004

(51) Int. Cl. H01F 27/42

(52) U.S. Cl. 307/412

(57) ABSTRACT

A push-pull device that is used in an output of a rear side of an uninterruptible power system, mainly comprises: a front-set driving circuit, a demagnetization circuit and an amplifying circuit; referring to the above, when pulse width wave signals PWMA and PWMB are input into a control circuit, the diodes and transistors of the front-set driving circuit conduct certain modulation such as continuously inverse the phase of and enhance the power of the signals PWMA and PWMB, which makes signals PWMA and PWMB be input to a transformer in turn, then signals PWMA and PWMB are amplified by the amplifying circuit to generate signals PWA and PWB, which conduct the demagnetization circuit so that the remanent magnetization on the transformer can be removed and the output in the rear side is steadier. Therefore, the whole control circuit is simplified and the number of inverse-change-tube can be reduced so as to reduce the design cost and efficiently demagnetize the remanent magnetization on the transformer.

### BACKGROUND OF THE INVENTION

1. Field of the Invention

A push-pull device that is used in an output of a rear side of an uninterruptible power system, mainly comprises: a front-set driving circuit, a demagnetization circuit and an amplifying circuit; referring to the above, when pulse width wave signals PWMA and PWMB are input into a control circuit, the diodes and transistors of the front-set driving circuit conduct certain modulation such as continuously inverse the phase of and enhance the power of the signals PWMA and PWMB, which makes signals PWMA and PWMB be input to a transformer in turn, then signals PWMA and PWMB are amplified by the amplifying circuit to generate signals PWA and PWB, which conduct the demagnetization circuit so that the remanent magnetization on the transformer can be removed and the output in the rear side is steadier. Therefore, the whole control circuit is simplified and the number of inverse-change-tube can be reduced so as to reduce the design cost and efficiently demagnetize the remanent magnetization on the transformer.

2. Description of Related Art

As technology develops with each passing day, computers are important to general enterprises and companies. For preventing data loss, most of enterprises and companies use uninterruptible power system (UPS) to prevent data loss when the electric power is cut out or the power is unsteady. Besides, the UPS can further be used as power supply and thus UPS now are necessary to general enterprises, companies, and even personal computers.

Referring to FIGS. 1, 2 and 3, while converting DC to AC, the conventional UPS uses full-bridge circuit as rear side output, which outputs signals by the upper-half bridge circuit and lower-half bridge circuit, each of the diagonal circuits of the full-bridge continuously modulates the pulse width to generate a half-period sine wave. The left, up half-bridge circuit and right, low half-bridge circuit are simultaneously conducted for outputting while the full-bridge circuit is operating, and at this time, the circuit outputs a positive (negative) half-period sine wave; the right, up half-bridge circuit and left, low half-bridge circuit are simultaneously conducted and the circuit outputs a positive (negative) half-period sine wave. The up half-bridge circuit and low half-bridge circuits are conducted in turn to continuously, alternatively output sine wave for generating a complete sine wave signal. The operation of the conventional full-bridge circuit to output sine wave are shown below:

As Q1 is a PWM square wave, Q3 is 60 HZ with high voltage, the PWM square waves of Q1 and Q2 are signals, whose phases are inverse to each other, at this time, Q2 will not output, and Q1 and Q3 are conducted to inversely change for outputting a positive-half-period wave signal.

Further, when Q2 is a PWM square wave, Q4 is 60 HZ with high voltage, the PWM square waves of Q1 and Q2 are signals, whose phases are inverse to each other, at this time, Q1 will not output, and Q2 and Q4 are conducted to inversely change for outputting a negative-half-period wave signal.

However, the full-bridge circuit needs at least four MOSFET (i.e. Q1, Q2, Q3, and Q4) to drive the output, each of the up half-bridge circuit and low half-bridge circuit needs two MOSET (Q1, Q2 of the up half-bridge circuit and Q3, Q4 of the low half-bridge circuit) to inversely change. The more MOSFET, the more power devices are needed and the cost is relative high; besides, each of the half-bridge circuits of the full-bridge circuit needs two sets of independent power for driving, which indirectly causes the design of the driving system and circuit to be more complicated and difficult and the manufacturing cost of the whole uninterruptible power system is increased so as to be complained by persons.

Consequently, because of the derivative defects from the conventional demagnetization method, the applicant keeps on carving unflaggingly through wholehearted experience and research to develop the present invention, which is more practical and a cost-down rear side output circuit.

### SUMMARY OF THE INVENTION

The main object of the present invention provides a push-pull device for using in an output at a rear side of an uninterruptible power system, the push-pull device used in the output at the rear side of the uninterruptible power system makes the output at the rear side steadier.

The second object of the present invention provides a push-pull device for using in an output at a rear side of an uninterruptible power system. The push-pull device is used as the rear side output of UPS to reduce the number of inversely change tubes and greatly reduce the cost of UPS.

Another object of the present invention provides a push-pull device for using in an output at a rear side of an uninterruptible power system. The push-pull device is used as the rear side output of UPS so that the design of UPS control circuit is simpler.

To achieve the above objects, the push-pull device comprises: a front-set driving circuit, a demagnetization circuit and an amplifying circuit;

Given the above, when pulse width wave signals PWMA and PWMB are input into a control circuit, the diodes and transistors of the front-set driving circuit conduct certain modulation such as continuously inverse the phase of and enhance the power of the signals PWMA and PWMB, which transfers signals PWMA and PWMB to signals Vga and Vgb and then input to a transformer in turn, then signals PWMA and PWMB are amplified by the amplifying circuit to generate signals PWA and PWB, which conduct the demagnetization circuit so that the remanent magnetization on the transformer can be removed and the output in the rear side is steadier. Therefore, the whole control circuit is simplified and the number of inverse-change-tube can be reduced so as to reduce the design cost and efficiently demagnetize the remanent magnetization on the transformer.

### BRIEF DESCRIPTION OF THE DRAWINGS

The drawings disclose an illustrative embodiment of the present invention which serves to exemplify the various advantages and objects hereof, and are as follows:

FIG. 1 is a schematic diagram that shows an up half-bridge circuit of a conventional full-bridge circuit;

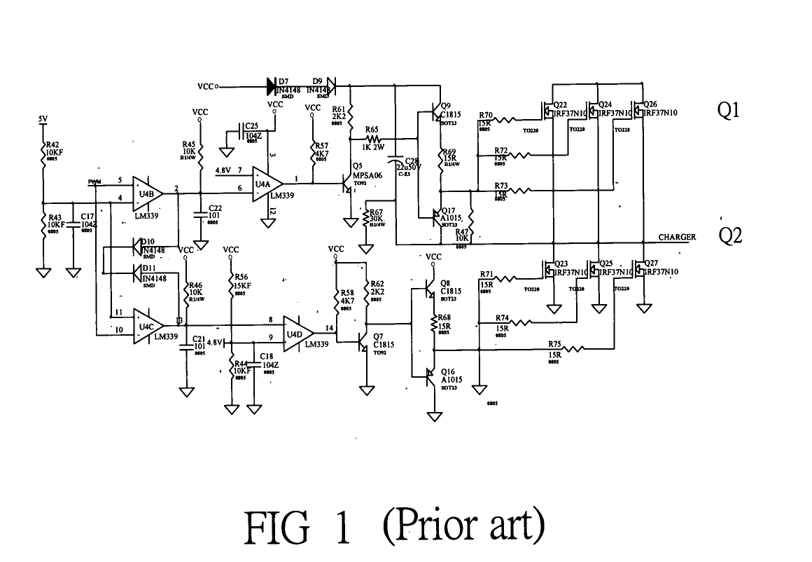

FIG. 2 is a schematic diagram that shows a low half-bridge circuit of a conventional full-bridge circuit;

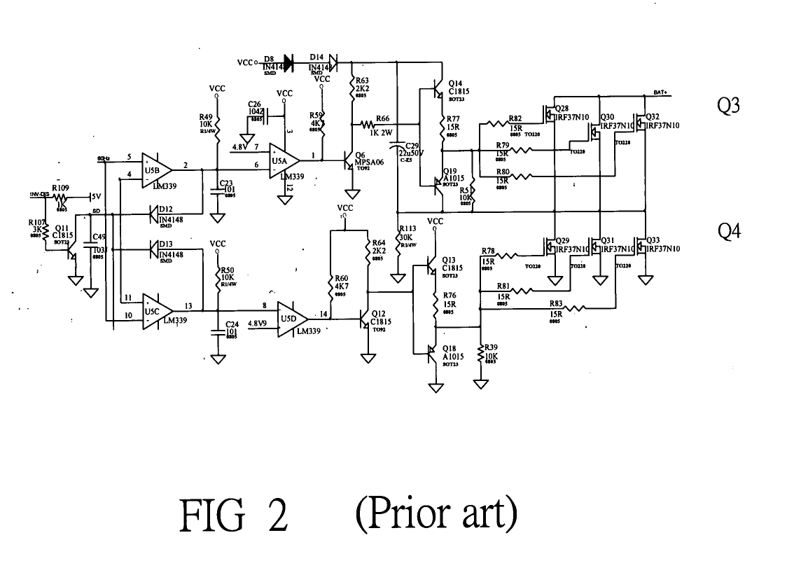

FIG. 3 is a schematic diagram that shows input and output waveforms of a full-bridge circuit;

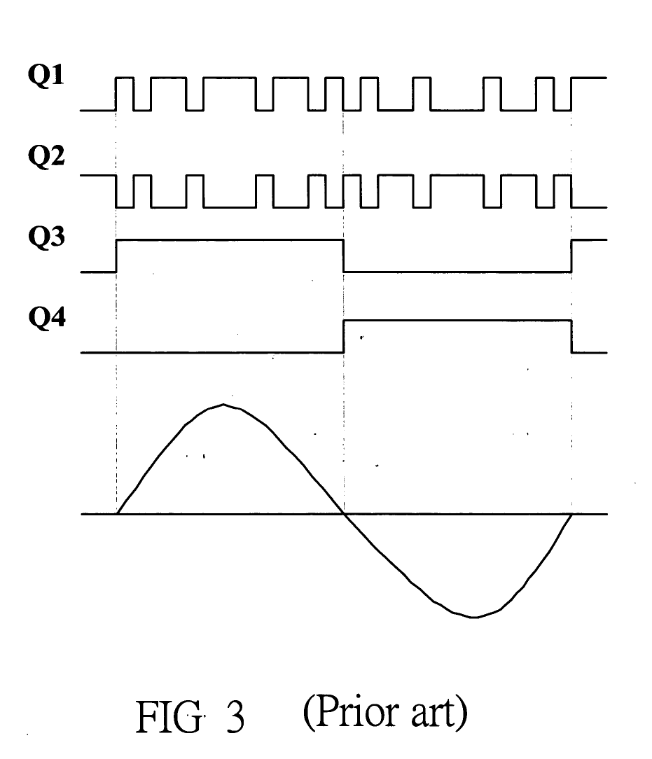

FIG. 4 is a schematic diagram that shows a circuit of the present invention;

FIG. 5 is a schematic diagram that shows an amplifying circuit of the present invention;

FIG. 6 is a schematic diagram that shows input and output waveforms of the present invention.

| | |
|---|---|
| 1 | Control circuit |
| 2 | Positive-half-period front-set driving circuit |
| Q4 | First transistor |
| Q18 | Second transistor |
| Q24 | Third transistor |
| Q26 | Fourth transistor |
| D16 | Diode |
| 3 | Negative-half-period front-set driving circuit |
| Q5 | First transistor |
| Q19 | Second transistor |
| Q25 | Third transistor |
| Q27 | Fourth transistor |
| D17 | Diode |
| 4 | Positive-half-period demagnetization circuit |
| Q12 | Transistor |
| D18 | Diode |
| 5 | Negative-half-period demagnetization circuit |
| Q13 | Transistor |
| D19 | Diode |
| 6 | Negative-half-period demagnetization driving amplifying circuit |
| Q16 | First transistor |
| Q22 | Second transistor |
| Q6 | Third transistor |
| 7 | Positive-half-period demagnetization driving amplifying circuit |
| Q17 | First transistor |
| Q23 | Second transistor |
| Q7 | Third transistor |
| 8 | Transformer |

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

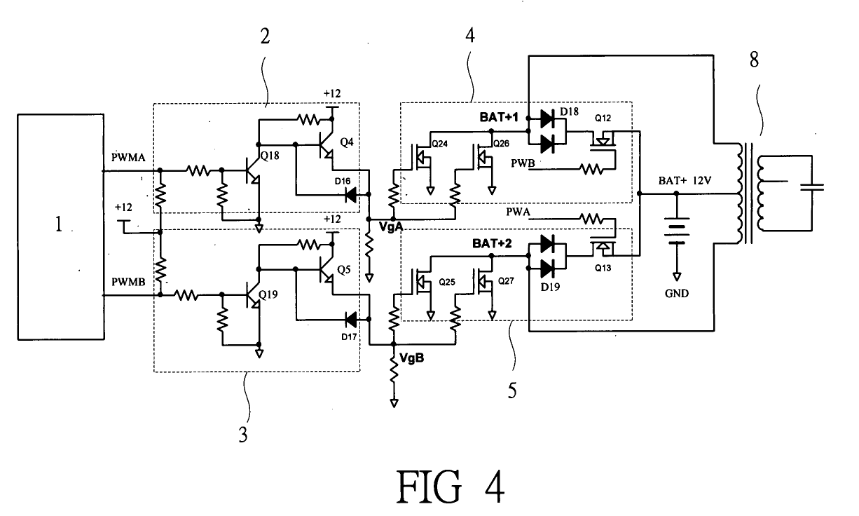

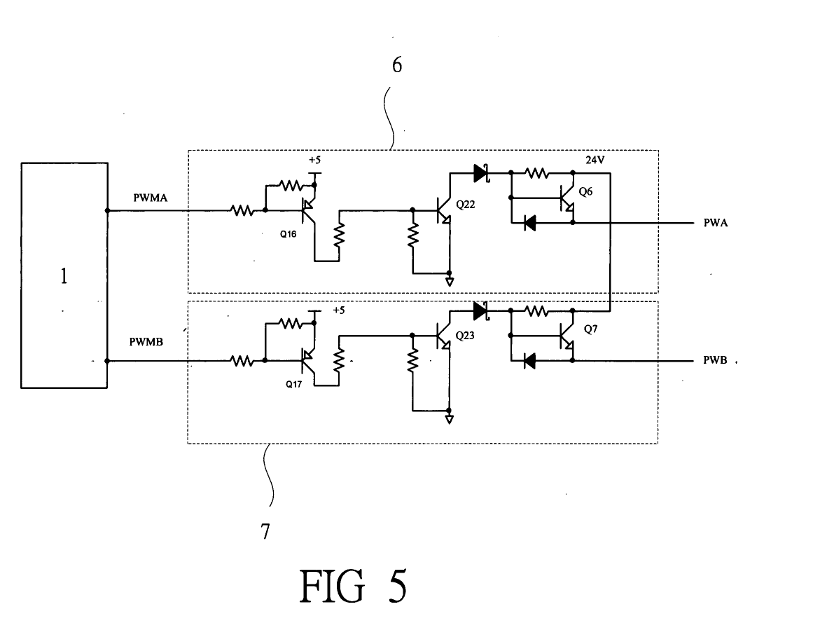

Referring to FIGS. 4 and 5, the present invention is directed to a push-pull device for using in an output at the rear side of an uninterruptible power system, the device mainly comprises:

a positive-half-period front-set driving circuit 2 for modulating a pulse width wave signal PWMA; the positive-half-period front-set driving circuit comprises a first transistor Q4, a second transistor Q18, a third transistor Q24, a fourth transistor Q26 and diode D16; the positive-half-period front-set driving circuit generates a signal Vga, which is inverse to PWMA.

a negative-half-period front-set driving circuit 3 for modulating a pulse width wave signal PWMB; the negative-half-period front-set driving circuit comprises a first transistor Q5, a second transistor Q19, a third transistor Q25, a fourth transistor Q27 and diode D17; the negative-half-period front-set driving circuit generates a signal Vgb, which is inverse to PWMB.

a positive-half-period demagnetization circuit 4 for demagnetizing remanent magnetization; the positive-half-period demagnetization circuit comprises a transistor Q12 and diode D18; the positive-half-period demagnetization circuit 4 sources signals from PMB.

a negative-half-period demagnetization circuit 5 for demagnetizing remanent magnetization; the negative-half-period demagnetization circuit comprises a transistor Q13 and diode D19; the negative-half-period demagnetization circuit 5 sources signals from PMA.

a negative-half-period demagnetization driving amplifying circuit 6 for inversely amplifying the pulse width wave signal PWMA; the negative-half-period demagnetization driving amplifying circuit comprises a first transistor Q16, a second transistor Q22 and a third transistor Q6;

a positive-half-period demagnetization driving amplifying circuit 7 for inversely amplifying the pulse width wave signal PWMB; the positive-half-period demagnetization driving amplifying circuit comprises a first transistor Q17, a second transistor Q23 and a third transistor Q7; and

a transformer having a plurality of coils for outputting power;

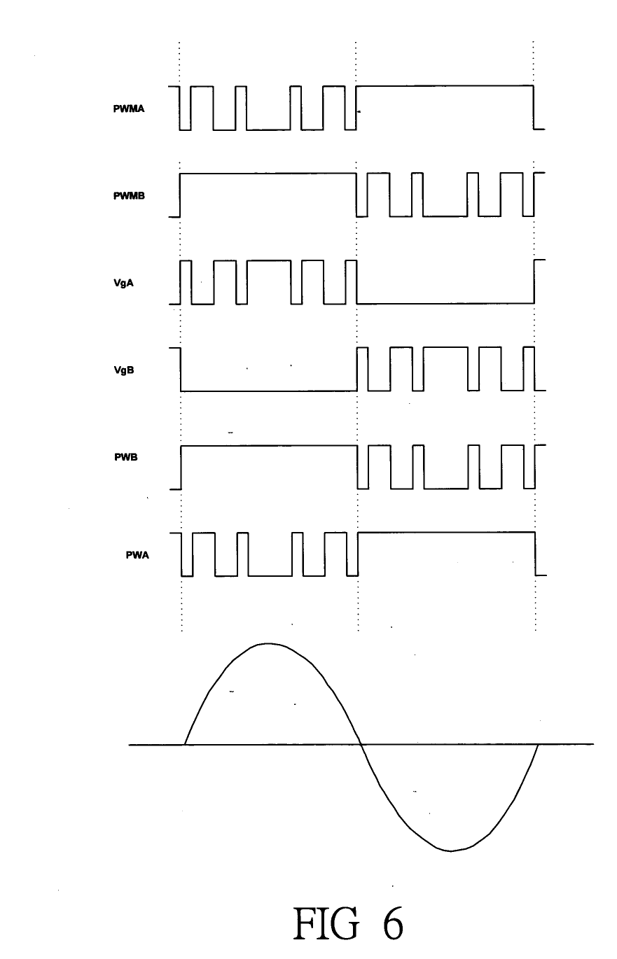

Referring to FIG. 4 and FIG. 6, when control circuit 1 outputs the pulse width wave signal PWMA to the positive-half-period front-set driving circuit 2 (at this time the negative-half-period front-set driving circuit 3 is off), the pulse width wave signal PWMA is inversed by the first transistor Q18, and the power of the pulse width wave signal PWMA is amplified to +12 V by transistor Q4 and then a signal VgA is formed (signal VgA is inverse to pulse width wave signal PWMA) to drive transistors Q24 and Q26 to inversely change, when transistors Q24 and Q26 are conducted and transmit power via transformer 8, a positive-half-period sine wave is obtained at the output waveform of the transformer 8.

Moreover, when control circuit 1 outputs the pulse width wave signal PWMB to the negative-half-period front-set driving circuit 3 (at this time the positive-half-period front-set driving circuit 2 is off), the pulse width wave signal PWMB is inversed by the first transistor Q19, and the power of the pulse width wave signal PWMB is amplified to +12 V by transistor Q5 and then a signal VgB is formed (signal VgB is inverse to pulse width wave signal PWMB) to drive transistors Q25 and Q27 to inversely change, when transistors Q25 and Q27 are conducted and transmit power via transformer 8, a negative-half-period sine wave is obtained at point C1 on the output waveform of the transformer 8.

According to the aforementioned, positive-half-period front-set driving circuit 2 and negative-half-period front-set driving circuit 3 alternatively output positive-half-period wave and negative-half-period sine wave, which makes the transformer continuously output a complete sine wave and power, and thus the rear side output of UPS is steadier.

Further, when the push-pull device of the interruptible power system is operating, positive-half-period front-set driving circuit 2 and negative-half-period front-set driving circuit 3 alternatively output signals (negative-half-period circuit is off while positive-half-period circuit is on). Therefore, when one of the front-set driving circuits is off, a voltage due to the leakage of inductance will generate magnetic field (i.e. remanent magnetization), which may cause distortion or short circuit at the output of transformer 8.

Referring to FIG. 5, for efficiently removing the above-mentioned remanent magnetization, a control circuit of the present invention outputs another pulse width wave signal PWMB to a positive-half-period demagnetization driving amplifying circuit 7 while the control circuit 1 outputs the pulse width wave signal PWMA to the positive-half-period front-set driving circuit 2. The pulse width wave signal PWMB is twice inversed by transistors Q17 and Q23, and the power thereof is amplified to +24V by transistor Q7, and then a pulse width wave signal PWB is generated to drive positive-half-period demagnetization circuit 4, the pulse width wave signal PWB drives transistor Q12 to be conducted so that the voltage formed over two sides of the transformer will pass through transistor Q12 and diode D18 and thus a short circuit is formed. Therefore, the transformer 8 demagnetizes the remanent magnetization, and at this time the negative-half-period demagnetization circuit 5 is off.

While the negative-half-period demagnetization circuit 5 is in an output state, the control circuit also outputs another pulse width wave signal PWMA to a negative-half-period demagnetization driving amplifying circuit 6. The pulse width wave signal PWMA is twice inversed by transistors Q16 and Q22 of the negative-half-period demagnetization driving amplifying circuit 6, and the power thereof is amplified to +24V by transistor Q6, and then a pulse width wave signal PWA is generated to drive negative-half-period demagnetization circuit 5, the pulse width wave signal PWA drives transistor Q13 to be conducted so that the voltage formed over two sides of the transformer will pass through transistor Q13 and diode D19 and thus a short circuit is formed. Therefore, the transformer 8 demagnetizes the remanent magnetization. The principle of pulse width wave signals PWA and PWB are the same, and the distinction thereof is that the phase of PWA is 180 degrees out of the phase of PWB. The above two pulse width wave signals alternatively operate for removing the remanent magnetization of transformer 8 so as to protect the lifetime of transformer 8.

The aforementioned push-pull device uses two front-set driving circuits to alternatively output such that the transformer can output a steady power and a complete sine wave, and indirectly make the rear side output steadier. The push-pull device can simplify the whole control circuit and reduce the number of inversely changed tubes. The push-pull device further inverses and amplifies the pulse width wave signals by the amplifying circuit and directs the signals into front-set driving circuit, which makes front-set driving circuit on and short. Hence, the remanent magnetization on the transformer 8 is efficiently removed. Therefore, the push-pull device can reduce the design cost of the circuit and efficiently remove the remanent magnetization.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

Given the above, the present invention is innovative in space and has the above effects as compared to the conventional products. The present invention really has novelty and inventive step and completely meets the applied element of new inveniton patent. The applicant applied for the present invention according to the Patent Law and the subject application should be examined in detail and granted a patent right to protect the inventor's right.

What is claimed is:

1. A push-pull device using in an output at a rear side of an uninterruptible power system comprising:
a positive-half-period front-set driving circuit for modulating a pulse width wave signal PWMA;
a negative-half-period front-set driving circuit for modulating a pulse width wave signal PWMB;
a positive-half-period demagnetization circuit for demagnetizing remanent magnetization;
a negative-half-period demagnetization circuit for demagnetizing remanent magnetization;
a positive-half-period demagnetization driving amplifying circuit for inversely amplifying the pulse width wave signal PWMB;
a negative-half-period demagnetization driving amplifying circuit for inversely amplifying the pulse width wave signal PWMA; and
a transformer having a plurality of coils for outputting power.

2. The push-pull device of claim 1, wherein the positive-half-period circuit comprises a first transistor, a second transistor, a third transistor, a fourth transistor and diodes.

3. The push-pull device of claim 1, wherein the negative-half-period circuit comprises a first transistor, a second transistor, a third transistor, a fourth transistor and diodes.

4. The push-pull device of claim 1, wherein the positive-half-period demagnetization circuit comprises transistors and diodes.

5. The push-pull device of claim 1, wherein the negative-half-period demagnetization circuit comprises transistors and diodes.

6. The push-pull device of claim 1, wherein the positive-half-period demagnetization driving amplifying circuit comprises a first transistor, a second transistor and a third transistor.

7. The push-pull device of claim 1, wherein the negative-half-period demagnetization driving amplifying circuit comprises a first transistor, a second transistor and a third transistor.
